(19) United States
(12) Patent Application Publication
(10) Pub. No.: US 2026/0065380 A1
(43) Pub. Date: Mar. 5, 2026

(54) SIMPLIFIED EXPENSE POLICY AND COMPLIANCE RECOMMENDATION WITH GENERATIVE AI

(71) Applicant: ORACLE INTERNATIONAL CORPORATION, Redwood Shores, CA (US)

(72) Inventors: Krishnakumar MENON, Fremont, CA (US); Udaykrishna CHIRTAPUDI, Foster CIty, CA (US); Kavin Kumar KUPPUSAMY, Fremont, CA (US)

(21) Appl. No.: 19/193,740

(22) Filed: Apr. 29, 2025

Related U.S. Application Data
(60) Provisional application No. 63/689,996, filed on Sep. 3, 2024.

(51) Int. Cl. G06Q 40/12

(52) U.S. Cl. CPC G06Q 40/12

(57) ABSTRACT

Systems, methods, and other embodiments associated with simplified expense policy and compliance enforcement based on generative AI are described. In one embodiment, an AI expense method includes retrieving a document that describes an expense policy. The AI expense method dynamically composes a prompt to a generative artificial intelligence model by populating a template prompt with the document. The prompt requests that the generative artificial intelligence model extract expense rules from the documents. The AI expense method generates the expense rules in response to the prompt with the generative artificial intelligence model. The generative artificial intelligence model is trained to produce the expense rules (i) to conform to the expense policy in the document, and (ii) in a format that is deployable to an expense management system. And, the AI expense method and deploys the expense rules to the expense management system.

### CROSS REFERENCE TO RELATED APPLICATIONS

This disclosure claims the benefit of U.S. Provisional Patent Application Ser. No. 63/689,996 filed Sep. 3, 2024, titled “SIMPLIFIED EXPENSE POLICY AND COMPLIANCE RECOMMENDATION WITH GENERATIVE AI”, having inventors: Krishnakumar MENON, Udaykrishna CHIRTAPUDI, and Kavin Kumar KUPPUSAMY, and assigned to the present assignee, which is incorporated by reference herein in its entirety.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates an example AI expense system that is associated with simplified expense policy and compliance enforcement based on generative AI.

FIG. 2 illustrates an example AI expense method which is associated with simplified expense policy and compliance enforcement based on generative AI.

FIG. 2A illustrates an example AI expense method as it operates in inquiry mode, which is associated with simplified expense policy and compliance enforcement based on generative AI.

FIG. 2B illustrates an example AI expense method as it operates in advisory mode, which is associated with simplified expense policy and compliance enforcement based on generative AI.

FIG. 2C illustrates an example AI expense method as it operates in authoring mode, which is associated with simplified expense policy and compliance enforcement based on generative AI.

FIG. 3 illustrates a data flow diagram for an example AI expense system that is associated with simplified expense policy and compliance enforcement based on generative AI.

FIG. 4 illustrates an architecture for an example AI expense system that is associated with simplified expense policy and compliance enforcement based on generative AI.

FIG. 5 illustrates an embodiment of a computing system configured with the example systems and/or methods disclosed.

### DETAILED DESCRIPTION

Systems and methods are described herein that provide simplified expense policy and compliance enforcement based on generative artificial intelligence (AI). In one embodiment, an AI expense system extracts policies from human language expense policy documents, and leverages expense policy documents as a retrieval augmented generation (RAG) source to enable real-time explanation and enforcement during expense creation.

In one embodiment, the AI expense system uses generative AI to automatically detect the expense policies from company expense policy documents for employees and converts them to expense policy definitions on an enterprise expense system, such as the Oracle® enterprise resource planning (ERP) Touchless Expense system. Thus, various policies are enabled to be automatically enforced during employee expense creation. The AI expense system further leverages generative AI by treating the company expense policy documents as a RAG source for one or more business units, and simplifies the implementation for customers by a great margin. The AI expense system ensures that expense policies are enforced in real-time during employee expense creation, thereby increasing companywide compliance of corporate travel and entertainment policies. The AI expense system significantly reduces manual effort in defining and enforcing and enforcing rules of an expense policy. The AI expense system reduces the risk of audit and compliance issues after expenses are incurred. This solution not only simplifies policy enforcement but also enhances compliance and operation efficiency for companies.

### Terms

Generative AI (GenAI). Generative AI (GenAI) refers to a type of artificial intelligence that creates new content, such as text, images, and music, based on patterns learned from existing data. Among the GenAI models that may be used for the AI expense system are GenAI large language models (LLMs) such as ChatGPT by OpenAI, LLAMA3, Claude by Anthropic, Google Gemini, Mistral AI, Grok, IBM Granite, Amazon Titan, Cohere Command, and a variety of other LLMs.

Retrieval-Augmented Generation (RAG). Retrieval-Augmented Generation (RAG) is a method for generating text using additional information fetched from external data source.

Vector DB. A database to store all the RAG sources.

Large language model (LLM). A large language model (LLM) is a type of artificial intelligence (AI) program that can recognize and generate text, among other tasks. The LLM is trained on massive amounts of text data and trained to generate text for a user input. In one embodiment, the LLM is configured to generate structured rules and/or unstructured rules from travel and expense policy documents.

BOSS. BOSS stands for Business Object Spectra Services. BOSS is an Oracle-managed cloud-native service that provides an abstraction layer over data. BOSS helps shape the way clients interact with the data and maintain a clean separation between an application's UI and data access. BOSS serves as an interface to perform various CRUD (Create, Read, Update, Delete) operations on data. Other cloud platforms may use other services or frameworks to implement similar functionalities.

### Example AI Expense System

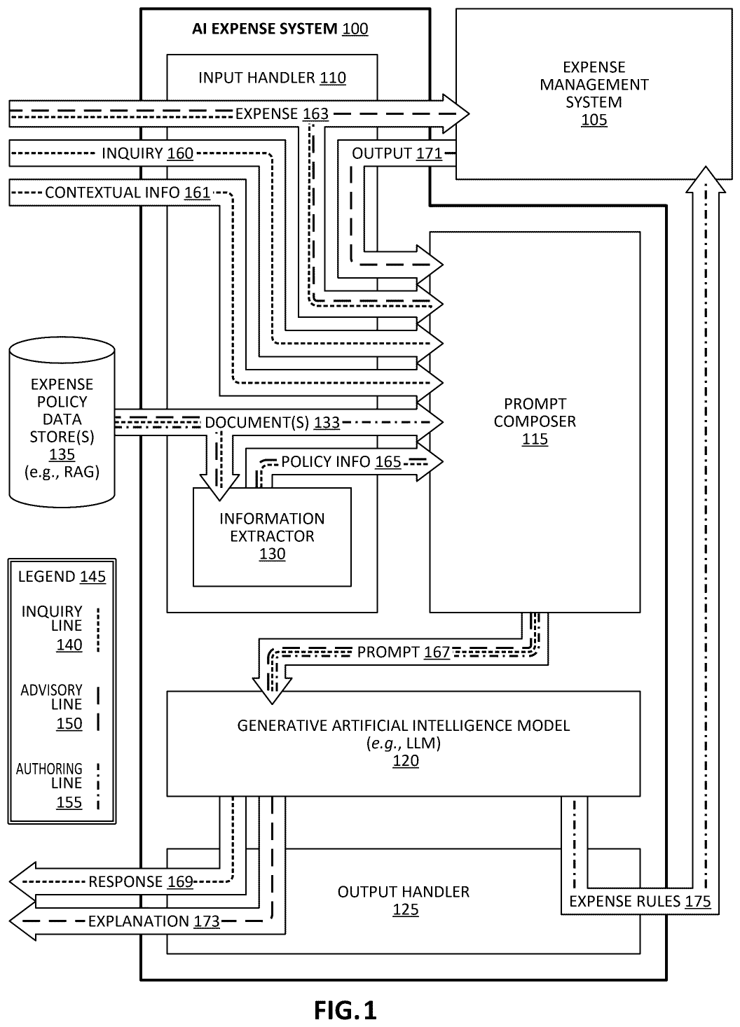

FIG. 1 illustrates one embodiment of a AI expense system 100 that is associated with simplified expense policy and compliance enforcement based on generative AI. In one embodiment, AI expense system 100 enables users to interact with an expense management system 105 in natural language and provides intelligent assistance for use of the expense management system 105. AI expense system 100 may be configured to operate in any of three distinct modes: an inquiry mode, an advisory mode, and an authoring mode. In the inquiry mode, AI expense system 100 is configured to answer user questions about expense policies. In the advisory mode, AI expense system 100 is configured to check or proofread an expense report and explain why the expense report will or will not be approved. In the authoring mode, AI expense system 100 is configured to write new expense business rules. In each of these modes, AI expense system 100 is configured to interact with a user in human language.

AI expense system 100 has various components, including a input handler 110, a prompt composer 115, a generative artificial intelligence (genAI) model 120, and an output handler 125. Input handler 110 may also include a information extractor 130. Input handler 110 may receive inputs from a user, and/or may access expense policy documents 133 in one or more data stores 135. Database 135 may include, for example a vector database of vectorized policy documents configured as a RAG source. In one embodiment, the components of AI expense system 100 and expense management system 105 intercommunicate in a network computing system, for example by electronic messages, as discussed below under the heading “Cloud or Enterprise Embodiments.” The components of AI expense system 100 are configured to make information that they generate available as output for downstream processing by one or more other components of AI expense system 100.

The data processing paths through the components of AI expense system 100 may differ between the inquiry mode, the advisory mode, and the authoring mode. The processing path for the inquiry mode is designated by an ‘inquiry’ line 140 having a first distinct pattern of dashes, as shown in legend 145. The processing path for the advisory mode is designated by an ‘advisory’ line 150 having a second distinct pattern of dashes, as shown in legend 145. The processing path for the authoring mode is designated by an ‘authoring’ line 155 having a third distinct pattern of dashes, as shown in legend 145.

Inquiry Mode. In one embodiment, when AI expense system 100 is configured to operate in the inquiry mode, input handler 110 is configured to accept input of an inquiry 160 and contextual information 161 about an expense 163. In one embodiment, the inquiry 160 is input by a user. In one embodiment, at least a portion of the contextual information 161 is retrieved by an agent from one or more data sources to provide additional information that is relevant to the inquiry 160. Contextual information 161 may also be input by the user.

And, input handler 110 is configured to retrieve policy information 165 from documents 133 that describe an expense policy. Input handler 110 may be configured to obtain documents 133 from one or more expense policy data stores 135. In one embodiment, information extractor 130 is configured to process documents 133 to extract the policy information 165. For example, information extractor 130 may be configured to extract the policy information 165 using natural language processing (NLP) techniques, regular expressions, or other language analysis tools that are configured to detect content of a document 133 that articulates rules or other parts of an expense policy.

Input handler 110 is configured to transmit the inquiry 160, contextual information 161, expense 163, and policy information 165 to prompt composer 115. In one embodiment, prompt composer 115 is configured to dynamically compose a prompt 167 to generative artificial intelligence model 120. Prompt composer 115 is configured to dynamically compose prompt 167 by populating a template prompt with the inquiry 160, the expense 163, the contextual information 161, and the policy information 165. The prompt 167 is configured to request a determination of whether the expense 163 is valid under the expense policy. Prompt composer 115 may be configured to retrieve and populate a template prompt that is associated with the inquiry mode, and which lays out the request to evaluate validity of the expense 163. Prompt composer 115 may be configured to transmit the populated prompt 167 to generative artificial intelligence model 130 for execution of the prompt 167. In one embodiment, the genAI model 120 is an LLM, and prompt composer 115 is configured to enter the prompt 167 into the LLM through a chat API endpoint.

In one embodiment, genAI model 120 is configured to generate a response 169 to the prompt 167. The generative artificial intelligence model 120 is trained to produce responses 169 that conform to the expense policy. In other words, the generative artificial intelligence model 120 is configured to produce responses 169 that adhere to the rules expressed by the policy (rather than violating the rules). The genAI model 120 may be fine-tuned to produce responses with improved accuracy to prompts 167 that follow the format of the template prompt that is associated with the inquiry mode. GenAI model 120 may be configured to transmit the response 169 through the chat API endpoint.

In one embodiment, output handler 125 is configured to present the response to the user. For example, output handler 125 is configured to listen for output of GenAI model 120 through the chat endpoint. Upon detection of the response 169, the output handler is configured to transmit the response 169 to a user interface for presentation (e.g., visually display, audibly play back, etc.) to the user.

Advisory Mode. In one embodiment, when AI expense system 100 is configured to operate in the advisory mode, input handler 110 is configured to capture user input of an expense 163 into an expense management system 105. And, input handler 110 is configured to intercept the output 171 by the expense management system 105 in response to the input of the expense 163. In other words, input handler 110 is configured to “listen in” on interactions between a client system and the expense management system 105, and where a submitted response is invalid, intercept output of the validation status and errors and replace or supplement them in the user interface with explanation. The output 171 includes validation status or one or more errors. Input handler 110 is further configured to retrieve policy information 165 from documents 133 that describe an expense policy. The retrieval is performed substantially as described above with reference to operation in the inquiry mode.

In one embodiment, prompt composer 115 is configured to dynamically compose a prompt 167 to a generative artificial intelligence model 120. Prompt composer 115 is configured to dynamically compose the prompt 167 by populating a template prompt with the expense 163, the output 171, and the policy information 165. The prompt 167 is configured to request an explanation of the output 171 in view of the expense policy. Prompt composer 115 may be configured to retrieve and populate a template prompt that is associated with the advisory mode, and which lays out the request explain output 171. Prompt composer 115 may be configured to transmit the populated prompt 167 to genAI model 130 (e.g., LLM) for execution, for example through a chat API endpoint.

In one embodiment, genAI model 120 is configured to generate an explanation 173 in response to the prompt 167. The genAI model is trained to produce explanations 173 that conform to the expense policy. The genAI model 120 may be fine-tuned to produce explanations 173 to prompts 167 that follow the format of the template prompt that is associated with the advisory mode to be more accurate than prompts that do not follow the format of the template prompt. GenAI model 120 may be configured to transmit the explanation 173 through the chat API endpoint.

In one embodiment, output handler 125 is configured to present the explanation 173 to the user. For example, output handler 125 is configured to listen for output of GenAI model 120 through the chat endpoint. Upon detection of the explanation 173, the output handler 125 is configured to transmit the explanation 173 to a user interface for presentation to the user.

Authoring Mode. In one embodiment, when AI expense system 100 is configured to operate in the authoring mode, input handler 110 is configured to retrieve a document 133 that describes an expense policy. In one embodiment, the document is a vector embedding of text contents of a policy document (referred to occasionally herein as a “RAG source”). In one embodiment, prompt composer 115 is configured to dynamically compose a prompt 167 to a generative artificial intelligence model 120. Prompt composer 115 is configured to dynamically compose a prompt 167 by populating a template prompt with the document. In one embodiment, the prompt incorporates the vector embedding of the document. The prompt 167 requests that the genAI model extract expense rules 175 from the document 133. Prompt composer 115 may be configured to retrieve and populate a template prompt that is associated with the authoring mode, and which lays out the request to extract expense rules 175. Prompt composer 115 may be configured to transmit the populated prompt 167 to genAI model 130 (e.g., LLM) for execution, for example through a chat API endpoint.

In one embodiment, genAI model 120 is configured to generate the expense rules 175 in response to the prompt 167. The genAI model is trained to produce the expense rules 175 to satisfy two conditions. First, the expense rules 175 are to conform to the expense policy in the document 133, that is, not violate the expense policy. Second, the expense rules 175 are to be in a format that is deployable to an expense management system 105. In one embodiment, the template prompt associated with the authoring mode may provide one-shot, few-shot, or many-shot examples of valid format(s) for expense rules 175 to reinforce conformance by the genAI to a format and style that is compatible with the expense management system 105. The genAI model 120 may be configured to generate the expense rules in a structured, machine-readable format using JSON, YAML, XML or other code rule definition. The genAI model 120 may be configured to include an expression of the condition logic for the expense rules 175.

In one embodiment, output handler 125 is configured to deploy the expense rules 175 to the expense management system 105. In one embodiment, output handler 125 is configured to listen at an API endpoint (e.g., a chat endpoint) of the genAI model 120 for output. Output handler 125 is configured to capture the expense rules (for example, packaged as a policy) from the API endpoint, push the rules into the live environment of the expense management system 105 through an API of the expense management system 105. Note that validation and testing of the expense rules may also be performed before placing them in the live environment. The output handler 125 may also be configured to transmit the expense rules 175 to a user interface for presentation to the user, and for potential validation and testing.

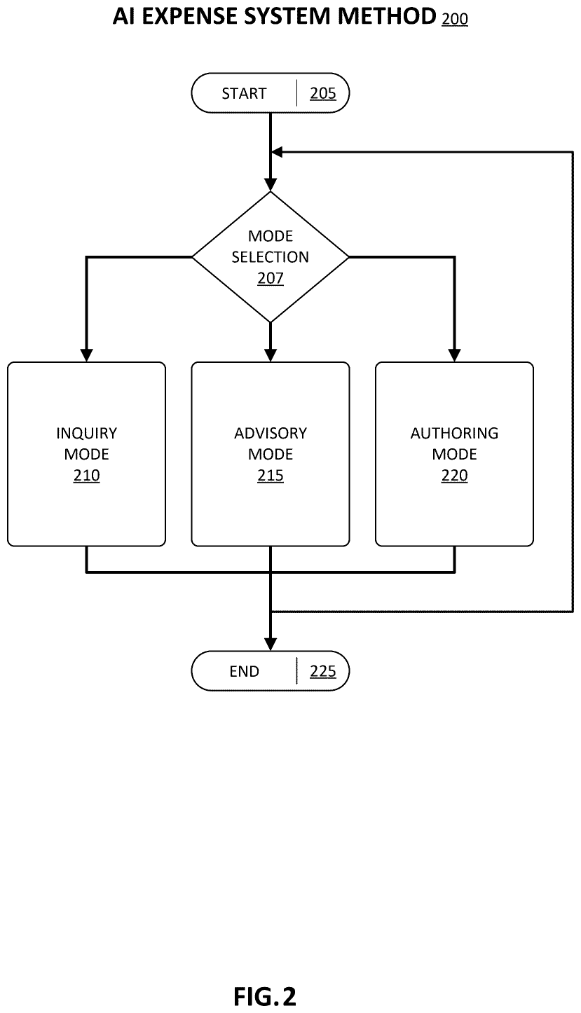

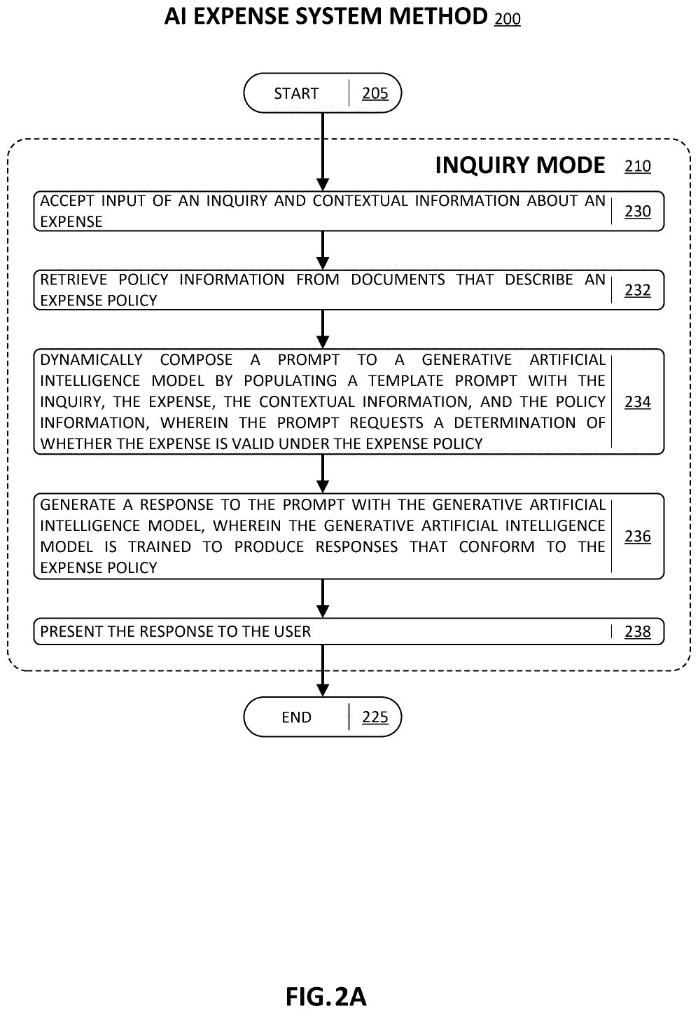

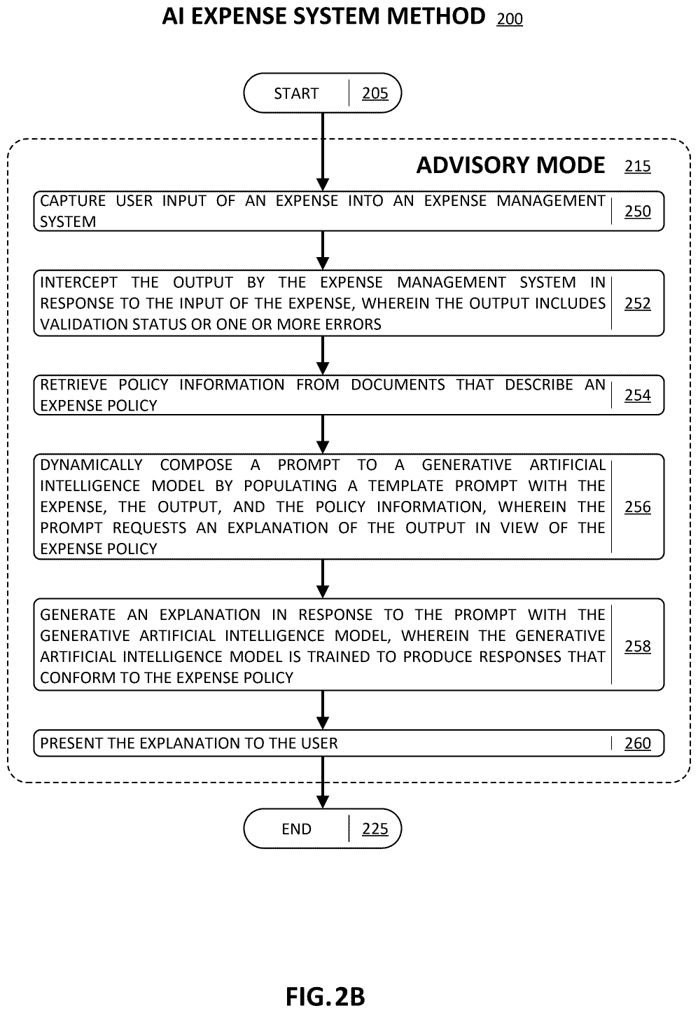

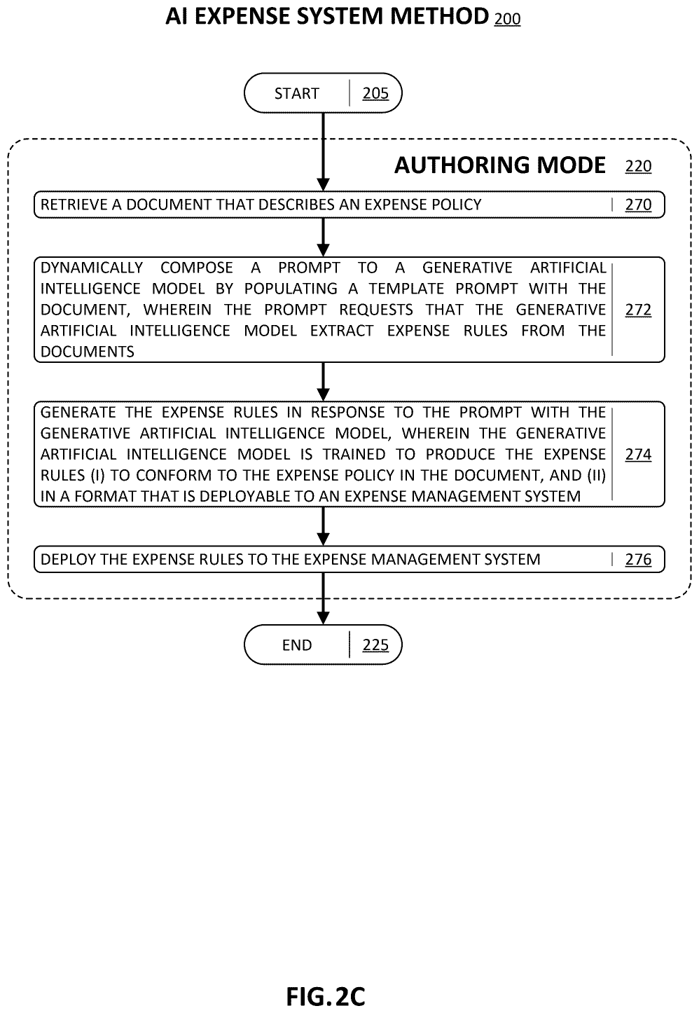

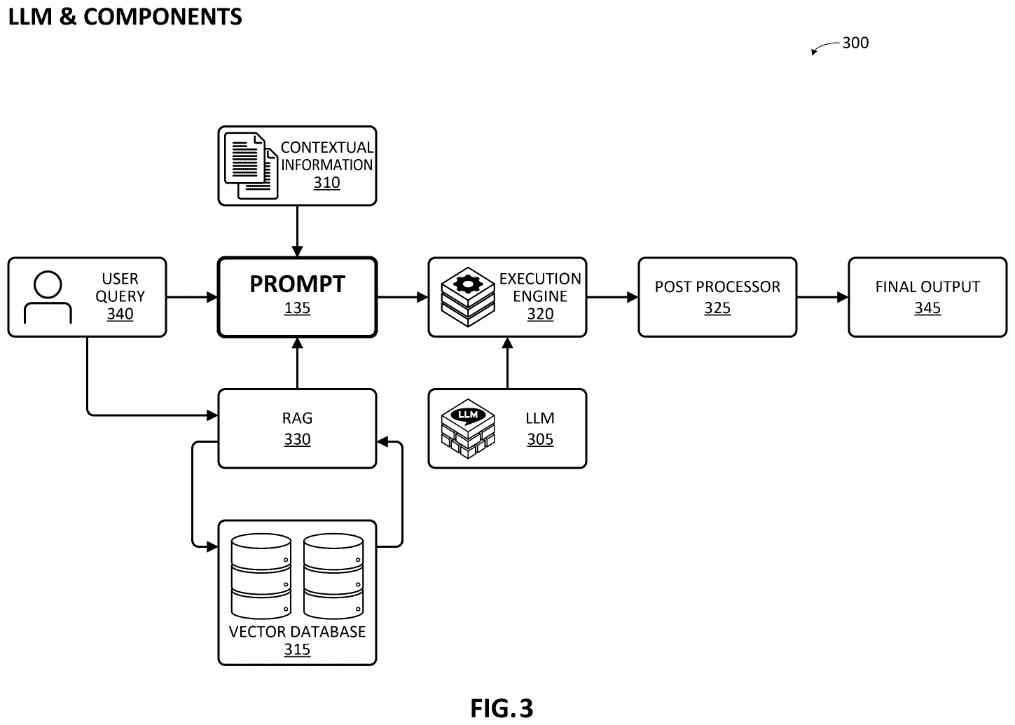

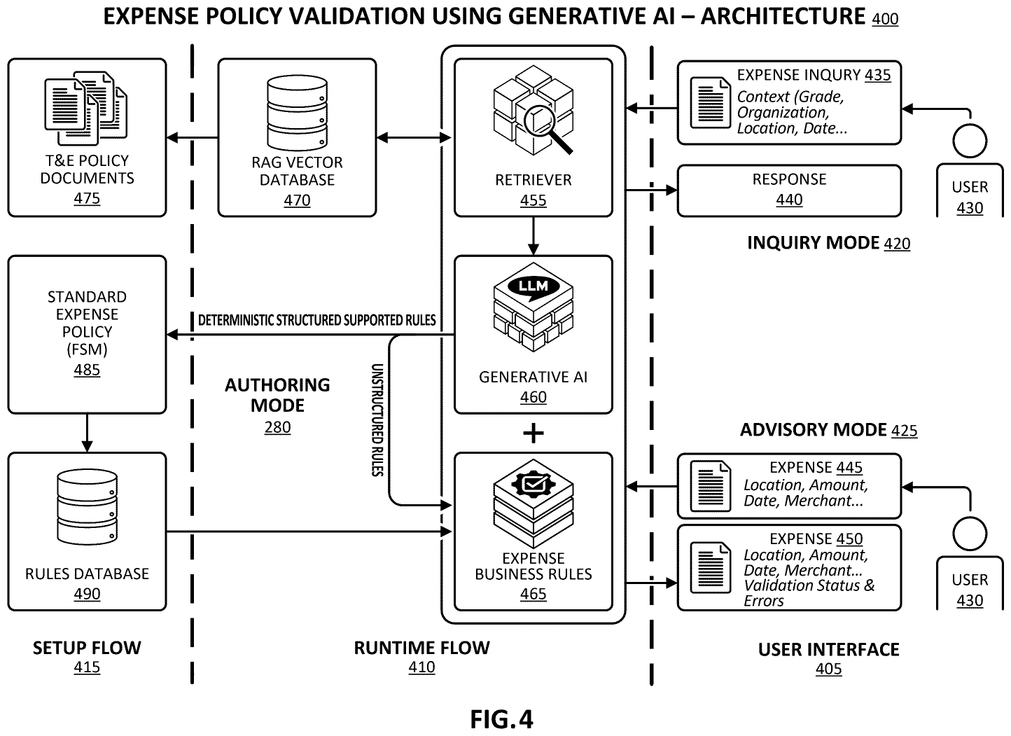

Further details regarding AI expense system 100 are presented herein. In one embodiment, an overview of operations of AI expense system 100 will be described with reference to AI expense method 200 of FIG. 2. In one embodiment, operations of AI expense system 100 in an inquiry mode 210 will be described with reference to FIG. 2A. In one embodiment, operations of AI expense system 100 in an advisory mode 215 will be described with reference to FIG. 2B. In one embodiment, operations of AI expense system 100 in an authoring mode 220 will be described with reference to FIG. 2C. In one embodiment, interactions between a LLM and various other components of AI expense system 100 will be described with reference to data flow diagram 300 of FIG. 3. In one embodiment, an example of integration of AI expense system 100 with an expense management system will be described with reference to architecture 400 of FIG. 4.

### AI Expense Methods

FIG. 2 illustrates one embodiment of an AI expense method 200 that is associated with simplified expense policy and compliance enforcement based on generative AI. In one embodiment, as a general overview, AI expense method 200 selects whether the AI expense system 100 is to operate in the inquiry mode, the advisory mode, or the authoring mode, and then launches and executes the selected mode.

In one embodiment, AI expense method 200 initiates at START block 205 in response to AI expense system 100 determining that one or more conditions or events have been detected or have occurred. The conditions or events for initiating AI expense method 200, include, but are not limited to, the following: (1) AI expense system 100 has received an instruction to: (i) determine if an expense is valid under a policy; (ii) explain an output from an expense system; or (iii) extract expense rules from a document. (2) AI expense system 100 has detected: (i) input directed to a genAI model of an inquiry about an expense; (ii) input directing an expense to an expense management system; or (iii) input of a document that describes an expense policy. (3) A user or administrator has initiated AI expense method 200. (4) it is currently a time at which AI expense method 200 is scheduled to be run; or (5) some other condition for commencing AI expense method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of AI expense system 100 executes AI expense method 200. In one embodiment, at START block 205, AI expense system 100 configures compute resources for performing AI expense method 200. (1) AI expense system 100 provisions (i.e., allocates and initializes) resources of the computing system that are used by AI expense system 100, such as processor, memory and storage (for example, for executing components of AI expense system 100). (2) AI expense system 100 establishes access to one or more networks for the resources, such as access to (a) internal networks for communication among components of AI expense system 100 and (b) external networks for communication with other computing systems (for example, client systems or expense management system 105). (3) AI expense system 100 connects to data sources (such as databases, data stores, file systems, and cloud storage) used by the AI expense method 200. And, (4) AI expense system 100 configures the computing system with system settings, software dependencies and libraries, and modules for executing the components of AI expense system 100.

Following initiation at START block 205, AI expense method 200 proceeds to mode selection 207. As used herein, a “mode” refers to a particular configuration of functionality executed by the AI expense system 100.

At mode selection 207, AI expense method 200 selects a mode in which to operate. AI expense method 200 checks user-provided information to determine which of an inquiry mode 210, an advisory mode 215, or an authoring mode 220 of the AI expense method 200 is to be performed. In one embodiment, the user may expressly instruct AI expense method 200 to operate in a designated mode, for example by selecting a button that designates the mode in a graphical user interface (GUI) to AI expense method 200, typing a command designates the mode into a command line interface (CLI) to AI expense method 200, or instructing an LLM to enter a designated mode.

In one embodiment, AI expense method 200 automatically determines a mode that corresponds to an input received by the AI expense system. For example, detection of an input of an inquiry about validity of an expense launches the inquiry mode 210. Detection of user input of an expense to the expense management system launches the advisory mode 215. Detection of an instruction to generate an expense policy or rule launches the authoring mode 220.

In one embodiment, the various modes may be individually operated as discrete methods. The method steps of a particular mode may be directly initiated, without undergoing mode selection 207. In one embodiment, less than all of the modes are deployed in AI expense system 100, or access to one or more of the modes may be restricted based on user permissions. In such cases AI expense method 200 is configured to execute just one or two of the modes, rather than all three. As an example, a user that lacks admin privileges may be able to launch the inquiry mode 210 and the advisory mode 215 (which do not operate to alter the expense management system 105), but not the authoring mode (which can deploy expense rules into the expense management system 105).

Based on the mode selection 207, AI expense method 200 proceeds to execute method steps for one of the inquiry mode 210, advisory mode 215, or authoring mode 220. AI expense method 200 may execute iteratively in an loop, returning to a state of waiting at mode selection 207 for further user inputs. Or. AI expense method 200 may conclude at END block 225 following execution of the method steps for one of the modes, if no further iteration of the loop is indicated.

Method steps for inquiry mode 210 are shown in and described with reference to FIG. 2A. Method steps for advisory mode 215 are shown in and described with reference to FIG. 2B. Method steps for authoring mode 220 are shown in and described with reference to FIG. 2C.

### AI Expense Method: Inquiry Mode

In one embodiment, the AI expense system 100 operates in an inquiry mode. FIG. 2A illustrates the example AI expense method 200 as it operates in inquiry mode 210, which is associated with simplified expense policy and compliance enforcement based on generative AI. In the inquiry mode 210, the AI expense system 100 proactively determines whether a proposed expense will be considered valid under a travel and expense policy (“expense policy” for short), and explains whether or not the expense is valid using human language (such as English).

In one embodiment, as a high-level overview of inquiry mode 210, an AI expense inquiry method accepts input of an inquiry and contextual information about an expense. The AI expense inquiry method retrieves policy information from documents that describe an expense policy. The AI expense inquiry method dynamically composes a prompt to a generative artificial intelligence model by populating a template prompt with the inquiry, the expense, the contextual information, and the policy information. The prompt requests a determination of whether the expense is valid under the expense policy. The AI expense inquiry method generates a response to the prompt with the generative artificial intelligence model. The generative artificial intelligence model is trained to produce responses that conform to the expense policy. And, the AI expense inquiry method presents the response to the user (for example by displaying the response, or transmitting the response to a computing device associated with the user along with electronic instructions to cause the response to be displayed to the user).

At block 230, AI expense method 200 accepts input of an inquiry and contextual information about an expense. AI expense method 200 may present a user interface that enables a user to enter an inquiry about an expense. This interface may operate through a web-based or application-based front end connected to back end services. When the user submits the inquiry, the system captures both the inquiry text and associated contextual information, such as expense amount, date, category, and geographic location. The AI expense method 200 may receive the inquiry as user input, and then operate to identify and retrieve context that will enrich the inquiry. For example, AI expense method 200 receives an expense question and some supporting context, and then executes agents to retrieve one or more missing items of context. The input and collected contextual data are temporarily stored in memory or a cache for prompt integration into a template prompt.

In one embodiment, AI expense method accept input of an inquiry and contextual information about an expense as follows. AI expense method 200 displays an input interface to the user for entering the inquiry and available contextual expense details. AI expense method 200 receives the inquiry and contextual data through the interface and transmits the input data to the back end service, for example using an API call. AI expense method 200 parses the incoming data at the back end to extract the inquiry and contextual information. AI expense method 200 validates the input data for completeness and format compliance. Where contextual information is incomplete or missing, AI expense method 200 identifies the particular items of context that are missing, and executes agents to obtain the missing context, if available to the AI expense system 100. AI expense method 200 stores the validated inquiry and context and makes it available for downstream processing.

In one embodiment, the steps of block 230 are performed by input handler 110. AI expense method 200 has been provided with an inquiry about an expense policy, and enriched the inquiry by collecting additional context that was not supplied with the inquiry. Processing continues to block 232.

At block 232, AI expense method 200 retrieves policy information from documents that describe an expense policy. For example, AI expense method 200 pulls policy information from expense policy documents that are stored as vectorized representations in a vector database, and decodes the policy information from the vector representation back into usable text format. The vector database may be configured for supporting retrieval augmented generation. The vector database AI expense method 200 gets policy information expense policy documents.

The AI expense system 100 may store expense policy documents in a vector database that indexes documents using high-dimensional embeddings. These documents are pre-processed by an embedding model to convert the text of the policy document into vector representations that are suitable for fast retrieval. When the user inquiry and expense context are received, the AI expense method 200 generates a search query based on the contextual data and inquiry. This query is used to retrieve relevant policy vectors from the vector database. The system performs similarity matching between the query vector and the stored policy vectors to identify applicable policies. The similarity matching may be based on a policy vector satisfying a threshold value for similarity to the query vector. The similarity value may be one of a variety of vector similarity metrics, such as cosine similarity, Euclidean distance, Jaccard similarity, or angular distance. Retrieved policy content is decoded back from its vector format into human-readable or machine-processable text. The retrieved policies provide context and content for prompt generation to the genAI (LLM). The retrieval process may consider multiple RAG sources to cover country-specific, department-specific, or other specific sets of policies.

In one embodiment, AI expense method 200 retrieves policy information from documents that describe an expense policy as follows. AI expense method 200 generates a query vector from the user inquiry and contextual data. AI expense method 200 searches the vector database for policy vectors similar to the query vector. AI expense method 200 identifies relevant policy documents based on similarity scores. AI expense method 200 retrieves the matched policy document content from the vector database. AI expense method 200 decodes the retrieved vectorized content back into text format. AI expense method 200 stores the retrieved policy information in temporary memory and makes the information available for downstream processing.

In one embodiment, the steps of block 232 are performed by input handler 100, information extractor 130, and/or data stores 135. AI expense method 200 has collected information that will be used by prompt composer 115 to generate a prompt to pose the inquiry to the genAI. Processing continues to block 234.

At block 234, AI expense method 200 dynamically composes a prompt to a generative artificial intelligence model by populating a template prompt with the inquiry, the expense, the contextual information, and the policy information. The prompt is configured to request a determination of whether the expense is valid under the expense policy. As used herein, the term “dynamically composes” indicates that the prompt is assembled at runtime. For example, AI expense method fills in a template that asks if an expense complies with a policy, given the contextual information.

AI expense system 100 may maintains a set of one or more template prompts that are structured to guide the language model in performing expense policy validation. Once the inquiry, expense details, contextual information, and policy data are collected, AI expense method 200 dynamically fills corresponding placeholders in the template prompt with this information. The template includes express instructions asking the model to determine if the expense complies with the retrieved policy, given the context. The populated prompt is then passed to the genAI for evaluation.

In one embodiment, AI expense method 200 dynamically composes a prompt to a generative artificial intelligence model as follows AI expense method 200 retrieves a pre-defined template prompt structure from system storage. The template prompt is associated with the inquiry mode, and is configured to pose the inquiry to the genAI in a standardized format that is consistent with the expected schema for the genAI. AI expense method 200 inserts the user inquiry, expense details, the contextual information, and the retrieved policy information into corresponding placeholders in the template. And, AI expense method 200 submits the prompt to the genAI, for example by transmitting the prompt to an API endpoint for input to the genAI.

In one embodiment, the steps of block 234 are performed by prompt composer 115. AI expense method 200 has thus initiated an analysis of the inquiry by the genAI. Processing continues to block 236.

At block 236, AI expense method 200 generates a response to the prompt with the generative artificial intelligence model, wherein the generative artificial intelligence model is trained to produce responses that conform to the expense policy.

After receiving the composed prompt at the genAI, the system submits it to an execution engine for the genAI. The execution engine loads a large language model which has been trained and has been fine-tuned with enterprise-specific expense policies and RAG sources. The execution engine processes the prompt, interprets the inquiry, expense details, context, and policy information, and generates a response that addresses the expense policy compliance question.

In one embodiment, AI expense method 200 generates a response to the prompt with the generative artificial intelligence model, as follows: The execution engine tokenizes the prompt by breaking the input text into smaller units, such as words or sub-word tokens, based on the trained vocabulary of the model. The execution engine converts the tokens into numerical embeddings using an embedding layer trained to represent semantic meanings. The execution engine passes the embeddings through multiple transformer layers, where self-attention mechanisms determine relationships between tokens and assign contextual weights. Positional encoding is added to the embeddings to preserve the order of tokens in the sequence. Individual transformer layers process the embeddings using feedforward neural networks and multi-head attention to build contextual understanding. The model applies learned weights and biases to compute output probabilities for the next token at each position in the sequence. A decoding mechanism, such as greedy search or beam search, selects the next most likely tokens to generate. The selected token sequence is progressively expanded until an end-of-sequence condition is reached or a token limit is met. The generated token IDs are mapped back to text using the model's vocabulary mapping.

During generation, the model applies reasoning across the provided context and policy to assess the validity of the expense. The output generally includes a clear determination (valid or invalid) and may include reasoning or references to the policy content. The response is structured to enable post-processing for user-friendly presentation. The response is then passed to downstream components for presentation to the user.

In one embodiment, the steps of block 236 are performed by genAI model 120. AI expense method 200 has prepared the response to the inquiry, and processing continues to block 238.

At block 238, AI expense method 200 presents the response to the user. AI expense method 200 captures the response, and routes the response to the user interface layer. The response is prepared for presentation by formatting it into a user-friendly display, which may include plain text or structured formats like JSON. The system transmits the response through an API to the client application interface. The client application displays the response within the inquiry session context to display to the user whether the expense is valid or invalid in real time in response to his or her inquiry. For example, AI expense method 200 may present the response to the user as follows: AI expense method receives the response from the AI execution engine, formats the response for presentation in the user interface, transmits the formatted response to the client application, and displays the response in the user interface. In one embodiment, the steps of block 238 are performed by output handler 125. Processing continues to end block 225, where the inquiry mode 210 of AI expense method 200 concludes.

### Example AI Expense Method: Advisory Mode

In one embodiment, the AI expense system 100 operates in an advisory mode. FIG. 2B illustrates an example AI expense method 200 as it operates in advisory mode 215, which is associated with simplified expense policy and compliance enforcement based on generative AI. In the advisory mode 215, the AI expense system 100 explains, in human language, why an expense entered into an expense management system is rejected or accepted.

In one embodiment, as a high-level overview of advisory mode 215, an AI expense advisory method captures user input of an expense into an expense management system. The AI expense advisory method intercepts the output by the expense management system in response to the input of the expense. The output includes validation status or one or more errors. The AI expense advisory method retrieves policy information from documents that describe an expense policy. The AI expense advisory method dynamically composes a prompt to a generative artificial intelligence model by populating a template prompt with the expense, the output, and the policy information. The prompt requests an explanation of the output in view of the expense policy. AI expense advisory method generates an explanation in response to the prompt with the generative artificial intelligence model. The generative artificial intelligence model is trained to produce responses that conform to the expense policy. The AI expense advisory method presents the explanation to the user.

At block 250, AI expense method 200 capture user input of an expense into an expense management system. In one embodiment, the AI expense method 200 monitors a communication session between a front-end client application and a back-end expense management system. For example the communication session may be surveilled by a middleware component or event listener. When the user submits the expense, the client application captures the input and transmits it to backend servers through an API call. The backend system parses the submitted data and validates it against predefined formats and schemas to ensure data integrity. In one embodiment, the steps of block 250 are performed by input handler 110. Processing continues to block 252.

At block 252, AI expense method 200 intercept the output by the expense management system in response to the input of the expense. The output includes validation status or one or more errors. After the user submits the expense, the expense management system performs initial validation checks based on configured business rules. The system then generates an output that includes the validation status, indicating whether the expense passes or fails compliance checks, and any errors detected, such as policy violations or missing information. A middleware component or event listener monitors the outbound responses from the expense management system. This component intercepts the output data stream before it is delivered to the user interface. The intercepted output includes structured data, such as status codes, error messages, and possibly references to violated policies. The middleware parses the intercepted output and prepares it for use in generating advisory prompts. Intercepting the output at this stage ensures that the advisory mode operates in real time and uses accurate system-generated feedback.

In one embodiment, AI expense method intercepts the output by: detecting the completion of expense processing by the expense management system; recording the outbound response generated by the expense management system; extracting the validation status and any error messages from the intercepted response, parsing the intercepted output to structure the data for advisory processing; and storing the parsed output for downstream prompt generation. In one embodiment, the steps of block 252 are performed by input handler 110. Processing continues to block 254.

At block 254, AI expense method 200 retrieves policy information from documents that describe an expense policy. Following interception of the expense management system's output, the advisory system retrieves relevant policy documents to provide explanations about the detected errors or validations. The policy documents have been pre-processed into vector representations and stored in the vector database to enable fast retrieval. Using the intercepted expense output as context, the system formulates a query to search the vector database. The query aims to find policy segments that relate specifically to the error codes, validation statuses, or the expense category involved. The vector database performs similarity matching and returns the most relevant policy documents or excerpts. Retrieved policy information is decoded and formatted for inclusion in the prompt assembly process.

In one embodiment, AI expense method retrieves policy information from documents that describe an expense policy by generating a query vector based on the intercepted output data; searching the vector database for policy vectors relevant to the query; retrieving matching policy documents or excerpts; decode the retrieved vectorized data into readable policy content; and storing the policy information for downstream prompt generation. In one embodiment, the steps of block 254 are performed by input handler 110, information extractor 130, and/or data stores 135. Processing continues to block 256.

At block 256, AI expense method 200 dynamically composes a prompt to a generative artificial intelligence model by populating a template prompt with the expense, the output, and the policy information. The prompt requests an explanation of the output in view of the expense policy. Once the expense data, system output, and relevant policy information have been collected, the system dynamically generates a prompt to guide the genAI model. Prompt composer 115 retrieves a predefined template designed for advisory mode explanations. The system populates the template placeholders with the captured expense details, the intercepted system output, and the retrieved policy information. The template includes specific instructions asking the AI to explain the meaning of the validation status and any errors in the context of the policy rules. The populated prompt is submitted to the genAI model 120.

In one embodiment, AI expense method 200 dynamically composes a prompt to a generative artificial intelligence model by retrieving a predefined advisory-mode template prompt from storage; inserting the expense details, intercepted output (including validation status and errors), and the retrieved policy information into the template prompt. The populated prompt is then submitted to genAI model 120. In one embodiment, the steps of block 256 are performed by prompt composer 115. Processing continues to block 258.

At block 258, AI expense method 200 generates an explanation in response to the prompt with the generative artificial intelligence model. The generative artificial intelligence model is trained to produce explanations that conform to the expense policy. The AI execution engine loads the trained language model, which has been fine-tuned with expense policy documents and relevant enterprise-specific data. The model processes the prompt, interprets the expense details, the system output, and the policy information, and generates an explanation of why the expense was accepted or rejected. Training ensures that the AI provides explanations that align with the company's expense policies and guidelines. The explanation typically includes references to the applicable policy rules and describes how the rules were applied to the expense. The output is structured to be easily parsed by downstream components for presentation. AI expense method 200 generates an explanation in response to the prompt with the generative artificial intelligence model in substantially the same manner as described above for inquiry mode 210 at block 236. In one embodiment, the steps of block 258 are performed by genAI model 120. Processing continues to block 260.

At block 260, AI expense method 200 presents the explanation to the user. In one embodiment, the explanation is substituted for or accompanies display of the output from the expense management system. Once the generative AI produces the explanation, the system routes the output to the user interface layer. The explanation may be formatted for clarity, potentially including visual indicators such as highlights or structured text showing policy references. The formatted explanation is sent through an API call to the client-side application. The application presents the explanation in the user interface, alongside the expense details and the system output for context. This allows the user to understand the reason for acceptance or rejection of the expense in real time. In one embodiment, the steps of block 260 are performed by output handler 125. Processing continues to end block 225, where the advisory mode 215 of AI expense method 200 concludes.

### Example AI Expense Method: Authoring Mode

In one embodiment, the AI expense system operates in an authoring mode. FIG. 2C illustrates an example AI expense method 200 as it operates in authoring mode 220, which is associated with simplified expense policy and compliance enforcement based on generative AI. In the authoring mode 220, the AI expense system automatically extracts (or otherwise automatically generates or derives) deployable expense rules from human-language expense policy documents.

In one embodiment, as a high-level overview of authoring mode 220, an AI expense rule authoring method retrieves a document that describes an expense policy. The AI expense rule authoring method dynamically composes a prompt to a generative artificial intelligence model by populating a template prompt with the document. The prompt requests that the generative artificial intelligence model extract expense rules from the documents. The AI expense rule authoring method generates the expense rules in response to the prompt with the generative artificial intelligence model. The generative artificial intelligence model is trained to produce the expense rules (i) to conform to the expense policy in the document, and (ii) in a format that is deployable to an expense management system. And, the AI expense rule authoring method deploys the expense rules to the expense management system.

At block 270, AI expense method 200 retrieves a document that describes an expense policy. The system maintains a repository of expense policy documents that have been uploaded by administrators or imported from corporate sources. These documents are embedded—encoded as high-dimensional vectors—and stored in a vector database. The embedded documents (also referred to herein as RAG sources) are indexed using their high-dimensional embeddings for fast retrieval. In authoring mode, the system initiates a retrieval request to obtain the vector embedding of an expense policy document. The request may target a specific document based on criteria such as geography, department, or policy category. The vector database processes the request and retrieves the selected policy document in its embedded, “vector-ized” form. The retrieved document serves as source material for generating deployable expense rules. The vector will be passed to the genAI model for direct analysis of the embedded form of the policy document.

The retrieval process is performed in substantially the same manner as described for inquiry mode 210 at block 232. In short, AI expense method 200 might retrieve a document that describes an expense policy by initiating a request to retrieve an expense policy document, searching the vector database for the requested document, and retrieving the selected policy document from storage. However, in the authoring mode, the embedded policy document is not decoded from vector format into human language text, but is instead left as-is. In one embodiment, the steps of block 270 are performed by input handler 110 and/or expense policy data stores 135. Processing continues to block 272.

At block 272, AI expense method 200 dynamically composes a prompt to a generative artificial intelligence model by populating a template prompt with the document, wherein the prompt requests that the generative artificial intelligence model extract expense rules from the vector-embedded documents. Once the policy document is retrieved, AI expense method 200 selects a pre-defined prompt template designed for authoring mode. This template includes a placeholder(s) intended to receive the vector of the embedded full policy document. AI expense method 200 inserts the vector policy document content into the placeholder(s) of the template for source material. The template includes an express instruction for the genAI to extract deployable expense rules from the document. Once populated, the prompt is passed to the execution engine of the genAI for processing.

In one embodiment, the steps of block 272 are performed by prompt composer 115. Processing continues to block 274.

At block 274, AI expense method 200 generates the expense rules in response to the prompt with the generative artificial intelligence model. The generative artificial intelligence model is trained to produce the expense rules (i) to conform to the expense policy in the document, and (ii) in a format that is deployable to an expense management system. The AI execution engine runs the trained language model to evaluate the prompt. The AI model has been fine-tuned using expense policy documents and examples of structured rule formats compatible with the expense management system. As the model processes the prompt, it analyzes the vector embedding of the policy text and extracts specific expense rules, such as limits, category restrictions, and approval requirements.

The genAI model is instructed by the prompt to structure expense rules that it generates to conform, if possible, to a syntax and data model employed by a rule engine of the expense management system. Where the expense rule is deterministic, and expressly defines conditions and outcomes, the genAI will generate the rule as a structured rule—an expense policy rule that is expressed in a formalized, machine-readable format that conforms to the syntax, schema, and execution specifications of a rule engine. Structured rules are amenable to automated enforcement by the rule engine. Example rule engines include Business Object Spectra Services (BOSS) and field service management (FSM), each of which may be employed by the expense management system.

Where the expense rules is not deterministic and/or ambiguously defines conditions or outcomes, the genAI will generate the rule as an unstructured rule—an expense policy rule that is expressed in natural language or semi-structured text that are interpretable by humans or genAI models, but which are not enforceable by deterministic system logic. Unstructured expense rules are not amenable to enforcement by a rule engine. However, a genAI such as an LLM may evaluate the applicability of an unstructured rule to an expense. Unstructured expense rules may remain as vectors for evaluation of expenses by the genAI. The genAI can be instructed to apply a vector-embedded expense rule to a vector-embedded expense, and determine if the unstructured rule is satisfied by the expense.

The generated rules may include either deterministic structured formats, annotations for any unstructured or advisory rules, or both. The generated rules are stored and made available for downstream processing.

In one embodiment, AI expense method generates the expense rules in substantially the same manner as described for inquiry method 210 above in block 236. In one embodiment, the steps of block 274 are performed by genAI model 120. Processing continues to block 276.

At block 276, AI expense method 200 deploys the expense rules to the expense management system. Once the genAI model outputs the structured expense rules, the AI expense method 200 prepares these rules for deployment into the expense management system. And, once the genAI model outputs the unstructured expense rules, the AI expense method 200 prepares these rules for deployment to enforcement by a genAI. The structured rules, formatted to match the expected schema of the expense rule engine, are transmitted through a deployment API or service connector. The AI expense system and/or expense management system may perform a validation step to ensure the rules are syntactically correct and do not conflict with existing rules that are already deployed. Deployment of structured rules involves storing the rules in the expense management system's rule database, making them active for real-time policy enforcement. Deployment of unstructured rules involves storing the vector-embedded rules in a RAG vector database, making them searchable by the LLM for real-time policy enforcement.

Upon successful deployment, the system registers the new rule set in its configuration registry to cause the structured and unstructured rules to be enforced. The deployment process is logged for compliance tracking and future audits. If supported, the system may notify administrators of the successful rule deployment. The deployed rules become immediately available for use in validating user-submitted expenses. This automation eliminates manual entry, reduces errors, and improves compliance with corporate policies.

In one embodiment, AI expense method 200 deploys the expense rules to the expense management system as follows. AI expense method 200 prepares the AI-generated rules for deployment by (for structured rules) validating their format and structure. AI expense method 200 transmits the rules to the expense management system through a deployment interface. AI expense method 200 stores the structured rules in the expense management system's rule database, such as standard expense policy (FSM) 485, Rules database 490, and or expense business rules 486 as shown in and described with reference to FIG. 4. AI expense method 200 stores the unstructured rules in a vector database associated with the expense management system. And, AI expense method 200 activates the rules for real-time use. In one embodiment, the steps of block 276 are performed by output handler 125. Processing continues to end block 225, where the authoring mode 220 of AI expense method 200 concludes.

### Example Additional Features of AI Expense Method

In one embodiment, when AI expense method 200 is operating in the inquiry mode 210, the dynamic composition of the prompt (discussed at block 234) further comprises including in the prompt a request to determine whether the expense is valid under the expense policy.

In one embodiment, when AI expense method 200 is operating in the inquiry mode 210, the method 200 further includes determining, using the generative artificial intelligence model, that the expense is not valid under the expense policy.

In one embodiment, when AI expense method 200 is operating in the inquiry mode 210, the dynamic composition of the prompt (discussed at block 234) further includes causing the computing system to select, as the template prompt, a first template prompt that is specifically configured for use in the inquiry mode.

In one embodiment, the generative artificial intelligence model is a large language model (LLM).

In one embodiment, when AI expense method 200 is operating in the inquiry mode 210, the retrieval of policy information from documents that describe an expense policy (discussed at block 232) further includes accessing a vector representation of the document in a vector database. And, the retrieval of policy information further includes decoding the vector representation of the document to obtain text of the document.

In one embodiment, when AI expense method 200 is operating in the inquiry mode 210, the AI expense method 200 further includes, prior to capturing user input of an expense into an expense management system, automatically selecting to operate in an advisory mode from among a set of modes that includes at the advisory mode and least one of an inquiry mode, and an authoring mode.

In one embodiment, when AI expense method 200 is operating in the advisory mode 215, presenting the explanation to the user (described at block 260) further includes selecting, as the template prompt, a first template prompt that is specifically configured for use in the advisory mode 215.

In one embodiment, the generative artificial intelligence model is one of a ChatGPT, Claude, or Cohere large language model (LLM).

In one embodiment, when AI expense method 200 is operating in the advisory mode 215, retrieving policy information from documents that describe an expense policy (discussed at block 254) further includes generating a query vector that includes the validation status or the errors. AI expense method 200 then searches a vector database with the query vector to obtain a vector representation of the document. And, AI expense method 200 decodes the vector representation of the document to obtain text of the document.

In one embodiment, when AI expense method 200 is operating in the advisory mode 215, after presenting the explanation to the user, AI expense method transitions to one of an inquiry mode or an authoring mode.

In one embodiment, when AI expense method 200 is operating in the advisory mode 215, prior to capturing user input of an expense into an expense management system, AI expense method 200 automatically selects to operate in an advisory mode from among a set of modes that includes at the advisory mode and least one of an inquiry mode, and an authoring mode.

In one embodiment, when AI expense method 200 is operating in the authoring mode 220, dynamically composing a prompt (discussed at block 272) further includes populating the template prompt with a vector embedding of the document.

In one embodiment, when AI expense method 200 is operating in the authoring mode 220, retrieving a document that describes an expense policy further includes loading the document as vector embedding of the document from a vector database.

In one embodiment, when AI expense method 200 is operating in the authoring mode 220, generating the expense rules further includes generating one or more of the rules as a rule that is compatible with business object spectra service (BOSS) or field service management (FSM).

In one embodiment, when AI expense method 200 is operating in the authoring mode 220, prior to retrieving the document that describes the expense policy, automatically selecting to operate in an authoring mode from among a set of modes that includes at the authoring mode and least one of an inquiry mode, and an advisory mode.

### Description and Discussion of AI Expense System: Problem Space

Most corporations tend to document all their travel and entertainment policies in various corporate websites with nuances specific to country/organizations on specific subpages. These are available for employees to read and adhere to. The same policies are used by business process owners and IT staff to create structured rules in their current Expense management system. Since there are limitations to the structured rule definitions, not all policies can necessarily be implemented into the system leaving for manual enforcements and potential gaps. Internal auditors also use the same documents as the basis for establishing guardrails and to enforce compliance within the corporation.

The above processes are time consuming, costly, and leave gaps in enforcement and ensuring compliance.

### Description and Discussion of AI Expense System: Example Solution

In one embodiment, the AI expense system resolves the problems with the above processes. Th solution provided by the AI expense system involves the ability to create effective policy documents, directly and effectively by interpreting the documents to create and enforce them as business rules within the expense management software (such as within the Touchless Expenses expense management software).

1. Corporate business process owners for expense management can convert their currently published travel and entertainment policy websites into PDF documents that can be consumed by Generative AI. Authoring these policy documents for easier consumption of the Generative AI can be achieved by following a standard template as published. A Generative AI module is available that can automate the process of taking any document and converting it into a standard format that makes it easier for the policy generator.

2. The policy document is loaded to the vector DB as a RAG source. There can be several RAG sources that represent policies for each country/region/organization as best befitting the corporate needs.

3. The Business Rule Generator engine will use the RAG sources to generate two sets of rules.

3a. Business Object Spectra Services (BOSS) Business Rules that can be interpreted and enforced by the BOSS business rules framework. The rules are generated to evaluate all the attributes of an expense document against the business rules by the expense management software (e.g., Touchless Expenses).

3b. Structured policies that can be used to create structured policy definitions that are supported by the expense management software (e.g., Touchless Expenses) system.

4. Any policies that do not fit the above two will be left as RAG sources to be used directly for policy validations/inquiry/advisory modes.

5. The system will deploy the generated business rules to the BOSS runtime environment as well as to field service management (FSM).

6. Users can create expenses in the expense management software (e.g., Touchless Expenses) and verify that the system is flagging appropriate compliance issues and providing suggestions to user on actions to be taken.

7. Expense business owners can fine tune their business rules by adjusting the policy documents and loading revisions in the vector database (DB), regenerate business rules, deploy and re-verify.

8. The expenses and expense reports submitted by the user, or the system will be verified by Generative AI against the appropriate RAG sources to ensure compliance. Any issues will be flagged with proper explanation generated with the help of Generative AI making it easier for users to rectify issues.

9. In addition to enforcing compliance via the business rules framework, the Generative AI model can also answer any questions that the user may have regarding policies or regarding any of their expenses and compliance issues. In this case Generative AI works in an advisory mode to help users address issues upfront and reduce processing overhead as well as expedite the reimbursement process. It combines public domain knowledge with the RAG sources specific to the enterprise to provide contextual suggestions on how to adhere to the corporate policies and ensure compliance.

10. Once satisfied after the iterative process, the business rules can be deployed to production.

### Description and Discussion of AI Expense System: LLM & Components

FIG. 3 illustrates a data flow diagram 300 for an example AI expense system that is associated with simplified expense policy and compliance enforcement based on generative AI. Data flow diagram 300 shows data interactions between a large language model (LLM) 305 and various other system components. The other components of AI expense system shown in data flow diagram 300 include contextual information 310, vector database 310, LLM execution engine 320, and post processor 325. Data moving between these various components includes retrieval augmented generation 330 of a prompt 335 from a user query 340. The prompt 335 is submitted to the LLM execution engine 320, which operates the LLM 305 on the prompt to produce output. The output is processed by post processor 325 to produce final output 345.

### Description and Discussion of AI Expense System: LLM & Architecture

FIG. 4 illustrates an architecture 400 for an example AI expense system that is associated with simplified expense policy and compliance enforcement based on generative AI. Architecture 400 includes 3 Us: a user interface (UI) layer 405, a runtime layer 410, and a setup layer 415.

UI layer 405 may be used in an inquiry mode 420, and in an advisory mode 425. In inquiry mode 420, a user 430 may enter an expense inquiry 435, and receive a response 440. In advisory mode 425, a user 430 may enter an expense 445, and receive an enhanced expense 450 that include validation status, errors, and AI generated explanation.

Runtime layer 410 operates to generate the response 440 and enhanced expense 450 based on the expense inquiry 435 and expense 445, respectively, received from UI layer 405. A retriever 455 generates prompts to a generative AI 460, and executes expense business rules 465 to produce the response 440 or the enhanced response 450. The retriever 455 may also access a RAG Vector DB 470 for added context to the prompts, or to analyze for policies. RAG Vector DB 470 includes travel & expense policy documents 475 that have been converted to high-dimensional vectors using an embedding model.

Generative AI 460 may be used in an authoring mode 480 to add deterministic structured rules supported by a FSM tool to a standard expense policy 485 of the FSM tool. The structured rules are stored in a rules database 490 that is accessible from the runtime layer 410. Expense business rules 465 collects the structured rules of the standard expense policy 485 from rules database 490, and provides them to the retriever for execution 455 along with the unstructured rules. Generative AI 460 may also be used in the authoring mode 480 to add unstructured rules that are not supported by the FSM tool to the expense business rules 465. Generative AI 460 generates the structured and unstructured rules from the embedded (vector-ized) travel & expense policy documents 475.

In setup layer 415, a user may provide travel & expense policy documents 475 and add or configure structured rules in the standard expense policy 485 of the FSM tool.

### Cloud or Enterprise Embodiments

In one embodiment, the AI expense system is a computing/data processing system including a computing application or collection of distributed computing applications for access and use by other client computing devices that communicate with the present system over a network. In one embodiment, AI expense system is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, AI expense system is a centralized server-side application that provides at least the functions disclosed herein and that is accessed by many users by way of computing devices/terminals communicating with the computers of AI expense system (functioning as one or more servers) over a computer network. In one embodiment AI expense system may be implemented by a server or other computing device configured with hardware and software to implement the functions and features described herein.

In one embodiment, the components of AI expense system may be implemented as sets of one or more software modules executed by one or more computing devices specially configured for such execution. In one embodiment, the components of AI expense system are implemented on one or more hardware computing devices or hosts interconnected by a data network. For example, the components of AI expense system may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of AI expense system intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of AI expense system may (i) generate or compose an electronic message or signal to issue a command or request to another component, (ii) transmit the message or signal to other components of AI expense system, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by AI expense system, for example through a web interface server. In one embodiment, the remote computing system may send requests to and receive responses from AI expense system. In one example, access to the information or applications may be effected through use of a web browser on a personal computer or mobile device. In one example, communications exchanged with AI expense system may take the form of remote representational state transfer (REST) requests using JavaScript object notation (JSON) as the data interchange format for example, or simple object access protocol (SOAP) requests to and from XML servers. The REST or SOAP requests may include API calls to components of AI expense system.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

### Computing Device Embodiment

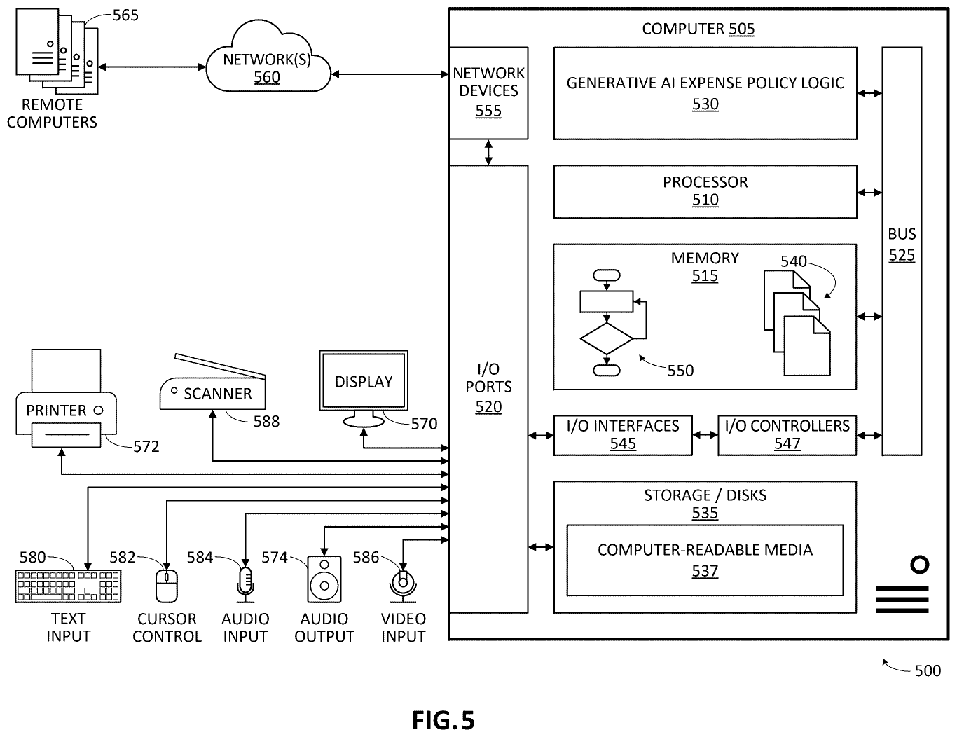

FIG. 5 illustrates an example computing system 500 that is configured and/or programmed as a special purpose computing device(s) with one or more of the example systems and methods described herein, and/or equivalents. The example computing device may be a computer 505 that includes at least one hardware processor 510, a memory 515, and input/output ports 520 operably connected by a bus 525. In one example, the computer 505 may generative AI expense policy logic 530 configured to facilitate simplified expense policy and compliance enforcement based on generative artificial intelligence, similar to the logic, systems, methods, and other embodiments shown in and described with reference to FIGS. 1, 2, 2A, 2B, 2C, 3, and 4.

In different examples, the logic 530 may be implemented in hardware, one or more non-transitory computer-readable media 537 with stored instructions, firmware, and/or combinations thereof. While the logic 530 is illustrated as a hardware component attached to the bus 525, it is to be appreciated that in other embodiments, the logic 530 could be implemented in the processor 510, stored in memory 515, or stored in disk 535.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate simplified expense policy and compliance enforcement based on generative artificial intelligence. The means may also be implemented as stored computer executable instructions that are presented to computer 505 as data 540 that are temporarily stored in memory 515 and then executed by processor 510.

Logic 530 may also provide means (e.g., hardware, non-transitory computer-readable medium that stores executable instructions, firmware) for performing one or more of the disclosed functions and/or combinations of the functions.

Generally describing an example configuration of the computer 505, the processor 510 may be a variety of various processors including dual microprocessor and other multi-processor architectures. A memory 515 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 535 may be operably connected to the computer 505 via, for example, an input/output (I/O) interface (e.g., card, device) 545 and an input/output port 520 that are controlled by at least an input/output (I/O) controller 547. The disk 535 may be, for example, a magnetic disk drive, a solid-state drive, a floppy disk drive, a tape drive, a Zip drive, a flash memory card, a memory stick, and so on. Furthermore, the disk 535 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 515 can store a process 550 and/or a data 540, for example. The disk 535 and/or the memory 515 can store an operating system that controls and allocates resources of the computer 505.

The computer 505 may interact with, control, and/or be controlled by input/output (I/O) devices via the input/output (I/O) controller 547, the I/O interfaces 545, and the input/output ports 520. Input/output devices may include, for example, one or more network devices 555, displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 535, and so on. The input/output ports 520 may include, for example, serial ports, parallel ports, and USB ports.

The computer 505 can operate in a network environment and thus may be connected to the network devices 555 via the I/O interfaces 545, and/or the I/O ports 520. Through the network devices 555, the computer 505 may interact with a network 560. Through the network 560, the computer 505 may be logically connected to remote computers 565. Networks with which the computer 505 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
accept input of an inquiry and contextual information about an expense;
retrieve policy information from documents that describe an expense policy;
dynamically compose a prompt to a generative artificial intelligence model by populating a template prompt with the inquiry, the expense, the contextual information, and the policy information;
generate a response to the prompt with the generative artificial intelligence model, wherein the generative artificial intelligence model is trained to produce responses that conform to the expense policy; and
present the response to the user.

2. The one or more non-transitory computer readable media of claim 1, wherein the computer-executable instructions to dynamically compose a prompt, when executed by at least the processor, cause the computing system to include in the prompt a request to determine whether the expense is valid under the expense policy.

3. The one or more non-transitory computer readable media of claim 1, wherein the computer-executable instructions when executed by at least the processor further cause the computing system to determine, using the generative artificial intelligence model, that the expense is not valid under the expense policy.

4. The one or more non-transitory computer readable media of claim 1, wherein the computer-executable instructions to dynamically compose a prompt, when executed by at least the processor, cause the computing system to select, as the template prompt, a first template prompt that is specifically configured for use in the inquiry mode.

5. The one or more non-transitory computer readable media of claim 1, wherein the generative artificial intelligence model is a large language model (LLM).

6. The one or more non-transitory computer-readable media of claim 1, wherein the computer-executable instructions to retrieve policy information from documents that describe an expense policy, when executed by at least the processor cause the computing system to:
access a vector representation of the document in a vector database; and
decode the vector representation of the document to obtain text of the document.

7. The one or more non-transitory computer-readable media of claim 1, wherein the computer-executable instructions, when executed by at least the processor cause the computing system to, prior to capturing user input of an expense into an expense management system, automatically select to operate in an advisory mode from among a set of modes that includes at the advisory mode and least one of an inquiry mode, and an authoring mode.

8. One or more non-transitory computer-readable media that include stored thereon computer-executable instructions that when executed by at least a processor of a computing system cause the computing system to:
capture user input of an expense into an expense management system;
intercept the output by the expense management system in response to the input of the expense, wherein the output includes validation status or one or more errors;
retrieve policy information from documents that describe an expense policy;
dynamically compose a prompt to a generative artificial intelligence model by populating a template prompt with the expense, the output, and the policy information, wherein the prompt requests an explanation of the output in view of the expense policy;
generate an explanation in response to the prompt with the generative artificial intelligence model, wherein the generative artificial intelligence model is trained to produce explanations that conform to the expense policy; and
present the explanation to the user.

9. The one or more non-transitory computer readable media of claim 8, wherein the computer-executable instructions to present the explanation to the user, when executed by at least the processor, further cause the computing system to replace or supplement the output in a user interface with the explanation.

10. The one or more non-transitory computer readable media of claim 8, wherein the computer-executable instructions to dynamically compose a prompt, when executed by at least the processor, cause the computing system to select, as the template prompt, a first template prompt that is specifically configured for use in the advisory mode.

11. The one or more non-transitory computer readable media of claim 8, wherein the generative artificial intelligence model is one of a ChatGPT, Claude, or Cohere large language model (LLM).

12. The one or more non-transitory computer-readable media of claim 8, wherein the computer-executable instructions to retrieve policy information from documents that describe an expense policy, when executed by at least the processor cause the computing system to:
generate a query vector that includes the validation status or the errors;
search a vector database with the query vector to obtain a vector representation of the document; and
decode the vector representation of the document to obtain text of the document.

13. The one or more non-transitory computer-readable media of claim 8, wherein the computer-executable instructions, when executed by at least the processor cause the computing system to, after presenting the explanation to the user, transition to one of an inquiry mode or an authoring mode.

14. The one or more non-transitory computer-readable media of claim 8, wherein the computer-executable instructions, when executed by at least the processor cause the computing system to, prior to capturing user input of an expense into an expense management system, automatically select to operate in an advisory mode from among a set of modes that includes at the advisory mode and least one of an inquiry mode, and an authoring mode.

15. One or more non-transitory computer-readable media that include stored thereon computer-executable instructions that when executed by at least a processor of a computing system cause the computing system to:
retrieve a document that describes an expense policy;
dynamically compose a prompt to a generative artificial intelligence model by populating a template prompt with the document, wherein the prompt requests that the generative artificial intelligence model extract expense rules from the document;
generate the expense rules in response to the prompt with the generative artificial intelligence model, wherein the generative artificial intelligence model is trained to produce the expense rules (i) to conform to the expense policy in the document, and (ii) in a format that is deployable to an expense management system; and
deploy the expense rules to the expense management system.

16. The one or more non-transitory computer-readable media of claim 15, wherein the computer-executable instructions to dynamically compose a prompt, when executed by at least the processor, cause the computing system to populate the template prompt with a vector embedding of the document.

17. The one or more non-transitory computer-readable media of claim 15, wherein the computer-executable instructions to retrieve a document that describes an expense policy, when executed by at least the processor, cause the computing system to load the document as vector embedding of the document from a vector database.

18. The one or more non-transitory computer-readable media of claim 15, wherein the computer-executable instructions to generate the expense rules, when executed by at least the processor, cause the computing system to generate one or more unstructured rules as vector embedding.

19. The one or more non-transitory computer-readable media of claim 15, wherein the computer-executable instructions to generate the expense rules, when executed by at least the processor, cause the computing system to generate one or more of the rules as a rule that is compatible with business object spectra service (BOSS) or field service management (FSM).

20. The one or more non-transitory computer-readable media of claim 15, wherein the computer-executable instructions, when executed by at least the processor cause the computing system to, prior to retrieving the document that describes the expense policy, automatically select to operate in an authoring mode from among a set of modes that includes at the authoring mode and least one of an inquiry mode, and an advisory mode.
